(19) United States
(12) Patent Application Publication
(10) Pub. No.: US 2010/0243845 A1
(43) Pub. Date: Sep. 30, 2010

(54) Tool hanger

(76) Inventor: Shayne Lepine, Salmon Arm (CA)

Correspondence Address: Antony C. Edwards, P.O. Box 26020, Westbank, BC, V4T 2G3, CA

(21) Appl. No.: 12/659,964

(22) Filed: Mar. 26, 2010

Related U.S. Application Data
(60) Provisional application No. 61/202,680, filed on Mar. 26, 2009.

(51) Int. Cl. F16M 13/00

(52) U.S. Cl. 248/315

(57) ABSTRACT

A tool hanger includes an elongate flexible member such as a chain, and a plurality of tool supports mounted spaced apart along the member. The tool supports may include hooks, loops, and rings. An upper end of the member is adapted to be mountable to a rigid support to allow the member to hang freely and downwardly by solely it's upper end. The tool supports each have opposite first and second sides in diametrically opposed relation. Each tool support is mounted to a corresponding mounting position along the member by the mounting of the first side of the tool support to the corresponding mounting position so as to dispose the second side of the tool support away from the corresponding mounting position on the member.

### CROSS REFERENCE TO RELATED APPLICATIONS

This application claims priority from U.S. provisional patent application No. 61/202,680, filed Mar. 26, 2009, entitled Tool Hanger.

### FIELD OF THE INVENTION

This invention relates to a tool hanger apparatus, and more specifically to a vertically suspended tool hanging device.

### BACKGROUND OF THE INVENTION

It is known that when using tools in the workshop or industrial environment, a means of storing the tools in an easily accessible position is advantageous. Similarly, storing these tools in an organized fashion assists in improving productivity of the workers using the tools. Often tools are stored in a toolbox, which may require the user to remove several tools from the toolbox before locating the tool they were searching for. Alternately tools may be stored on the workbench, leading to a cluttered work area and less room to perform the work or place the parts to be worked upon. Pegboards with hook or arm extensions do provide a means for storing tools, but it requires the user to have adequate wall space, and involves much initial setup effort.

Because keeping tools in these aforementioned locations is undesirable or requires special conditions, it is desirable to have an easy to set up system of storing tools, both in order to keep them readily available and at hand while performing the work, and to keep them organized for longer term storage.

Some common devices, designed to provide solutions to these problems, include horizontally disposed tool racks which mount to the wall and are useful for holding screwdrivers and other small hand tools. However devices capable of supporting the weight of many heavier tools such as cordless drills, electric saws, or vertically suspended hanging systems for other objects are not as common in the art. Applicant is aware of patents regarding such examples as:

U.S. Pat. No. 6,688,568 which issued to Moufflet on Feb. 10, 2004, titled “Fixing Device Comprising a Rod Hooked on a Wall,” teaches a vertical rod and hook system intended for mounting upon the wall, in order to hold objects at a vertically adjustable height. The mounting system of the Moufflet device is complicated and requires an anchorage rail for the vertical rod to be suspended from. The system involves the tightening and loosening of individual hook elements to move them vertically along the rod, requiring the user to spend time making adjustments each time a different tool is to be hung.

U.S. Pat. No. 5,853,092 which issued to Goodman and Milman on Dec. 29, 1998, titled “Self-Adapting Tool Rack,” discloses a board of evenly spaced hooks with each hook able to fold flush with the board or extend out from the board. In this fashion different tool hanging arrangements can be made easily and quickly by folding or extending the appropriate hooks. However in applicant's view the strength of the rack may not be suitable for heavy tools, and because the hooks are attached to a board, larger tools may not fit on the hooks.

U.S. Pat. No. 5,743,416 which issued to Yemini on Apr. 28, 1998, titled “Tool Rack”, teaches a horizontally mounted tool rack which provides different apertures for differently shaped tools. The disadvantages in applicant's opinion of storing tools using the device include the requirement for wall mounting space, and the fact that this device may not easily support larger tools, for example drills and electric saws.

U.S. Pat. No. 5,603,418 which issued to Tellefsen on Feb. 18, 1997, titled “Hanger for Baby Care Products,” teaches a hanging device with a plurality of hook or ring shaped extensions, suitable for holding baby care products. This device allows easy access to the objects stored on the extensions, but the strength of the construction may be unsuitable for heavy tools. In addition, in applicant's view, its design requires a large area of open space to store and hang the objects, while a tool hanger with a small footprint is more desirable in the workshop.

U.S. Pat. No. 4,141,452 which issued to Martin et al. on Feb. 27, 1979, titled “Tool Hanger,” teaches a device with a separate mounting bracket and gripping member, connected via chain or cable. The device is capable of holding a large and heavy tool, such as a garden fork or shovel. However the device is not adaptable for different types of tools, such as the ones found in the typical industrial setting, or home workshop. Additionally the Martin patent does not allow for multiple tools to be hung from the same mounting bracket. This means each tool is required to have a separate mounting bracket, which requires in applicant's opinion a large mount of initial setup time.

U.S. Pat. No. 4,071,146 which issued to Batts on Jan. 31, 1978, titled “Articulated Article Support,” discloses a vertical hanging device consisting of a spine and a series of hooks attached to this spine. In applicant's view, the device was designed for hanging clothing articles, and not meant to, nor adapted to support the additional weight and different sizes and shapes of industrial tools.

U.S. Pat. No. 2,609,104 which issued to Leach on Sep. 2, 1952, titled “Multiple Coat Hanger Support,” teaches a device consisting of a wire bent into a series of consecutive loops, suitable for holding a plurality of coat hangers in a vertical position. As will the Batts device, this device is not in applicant's view suitable for supporting some or all industrial tools.

The present invention serves to address the deficiencies in the art, by providing a device which can support multiple types of tools, which have varying sizes, shapes and weights, while allowing the user maximum flexibility to organize their tools without spending excessive setup and configuration time.

### SUMMARY OF THE INVENTION

The present invention may include a plurality of loops, hooks, arms or other extensions of differing shapes and sizes that are well adapted to support different shapes sizes and weights of industrial tools. The extensions are attached, either rigidly or so as to hang free, to a length of chain, or flexible cable, tether or other flexible, strong tensile, elongate member in a vertically disposed fashion. In a preferred application, tools such as handsaws and clamps are suspended from hooks as well as other tools having eyelets such as many electric drills, electric saws, etcetera, while other tools such as screwdrivers, ratchets, hammers, pliers, axes are held by appropriately sized loops. The arms may also be used to support larger tools such as power drills or saws. Different shapes of extensions may be manufactured to support tools as required.

In summary, the tool hanger according to one aspect of the present invention may be characterized as including an elongate flexible member, and a plurality of tool supports mounted spaced apart along the member, wherein the tool supports are chosen from the group of supports that include hooks, loops, and rings. A first end of the member is adapted to be an upper end when the member is vertical and so as to be mountable to a rigid support to allow the member to hang freely and downwardly by solely it's upper end.

The tool supports each have opposite first and second sides in diametrically opposed relation. Each the tool support is mounted to a corresponding mounting position along the member by the mounting of the first side of the tool support to the corresponding mounting position so as to dispose the second side of the tool support away from the corresponding mounting position on the member.

In one embodiment at least one of the plurality of tool supports is a free hanging tool support mounted to the member so as to hang free from the member thereby allowing free movement of the free hanging tool support suspended by it's first side from the mounting position.

In one embodiment the flexible member is a length of chain comprising a linked series of chain links, wherein the free hanging tool support is mounted to a corresponding link in the chain. In a further embodiment, all of the tool supports are free hanging tool supports.

At least one, or all of the free hanging tool supports may be releasably mounted to their corresponding links for example by the use of clasps or other releasable fasteners. In another embodiment none of the free hanging tool supports are releasable from their chain links, but instead are permanently affixed.

The tool supports are mounted along the chain in a spaced apart array. They may be both spaced longitudinally along the chain and spaced apart radially around the chain, that is, radially spaced relative to the longitudinal axis of the chain when linear, for example when hanging free by it's upper end.

When the tool supports include rings, the rings may include rings of different diameters. Such rings may include first rings having a first diameter and second rings having a second diameter, wherein the first diameter is less than the second diameter, whereby the first and second rings are adapted to hold elongate parts of hand tools when the elongate parts are journalled therethrough, depending on the size of the tool.

The tool supports may also include hooks chosen from the group comprising: S-hooks, u-shaped hooks, single hooks, double-ended hooks. One of the hooks may be mounted at the second or lower end of the flexible member so as to hang below the lower-most end of the member when the member is hanging by the upper end and the member is hanging free. Another of the hooks may be mounted at the upper end of the flexible member so that the flexible member may be suspended thereby.

Advantageously the tool supports are adjustably positionable along the length of the member. They may also be adjustably positionable radially about the longitudinal axis of the member.

### BRIEF DESCRIPTION OF THE DRAWINGS

FIG. 1 is, in isometric view, one embodiment of the tool hanger of the present invention.

FIG. 1a is, in front perspective view, an example of a tool being stored in the tool hanger.

FIG. 2 is, in isometric view, an alternative embodiment of the tool hanger of the present invention, using freely suspended hooks, both single and double-ended mounted on links of the chain links.

FIG. 2a is a side elevation view of a further hook embodiment mounted so as to hang freely from a link of the chain of FIG. 2.

FIG. 2b is a side elevation view of a single ring embodiment mounted so as to hang freely from a link of the chain of FIG. 2.

FIG. 2c is a side perspective view of a double ring embodiment mounted so as to hang freely from a link of the chain of FIG. 2.

FIG. 2d is an elevation view of the hook of FIG. 2a mounted to a spring-loaded clasp for releasably mounting the hook to the chain of FIG. 2.

FIG. 2e is an elevation view of the ring of FIG. 2b mounted to a spring-loaded clasp for releasably mounting the ring to the chain of FIG. 2.

FIG. 3 is, in isometric view, a further alternative embodiment of the tool hanger of the present invention, with a cable and double cylindrical connectors in the place of the chain links.

FIG. 4 is, in isometric view, a further alternative embodiment of the tool hanger of the present invention, using hooks in the place of loops or other tool attachment means.

FIG. 5 is, in isometric view, a further alternative embodiment of the tool hanger of the present invention, which includes keyhole rings mounted to bumps, knots or the like formed along the length of a rubber bungee or rubber cord or the like.

### DETAILED DESCRIPTION OF EMBODIMENTS OF THE INVENTION

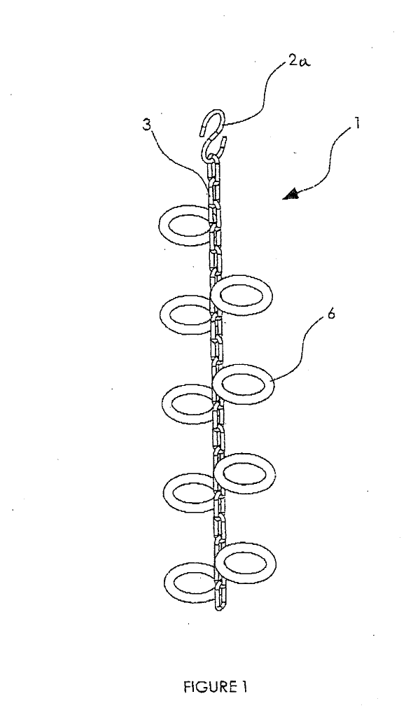

As seen in FIG. 1, tool hanger 1 is suspended from a nail (not shown) or the like mounted into a wall, stud, joist, etcetera by S-hook 2a. Hanger 1 includes chain links 3 on which are mounted rings 6 spaced apart along the length of chain. In one embodiment, the rings are attached to the links by welding. As seen in FIG. 1a, a screwdriver 9 is suspended in a ring 6 by the thin end 9a of the screwdriver being inserted downwardly through the ring. The length of the chain may be varied depending on the mounting location. For example the chain may be two feet long.

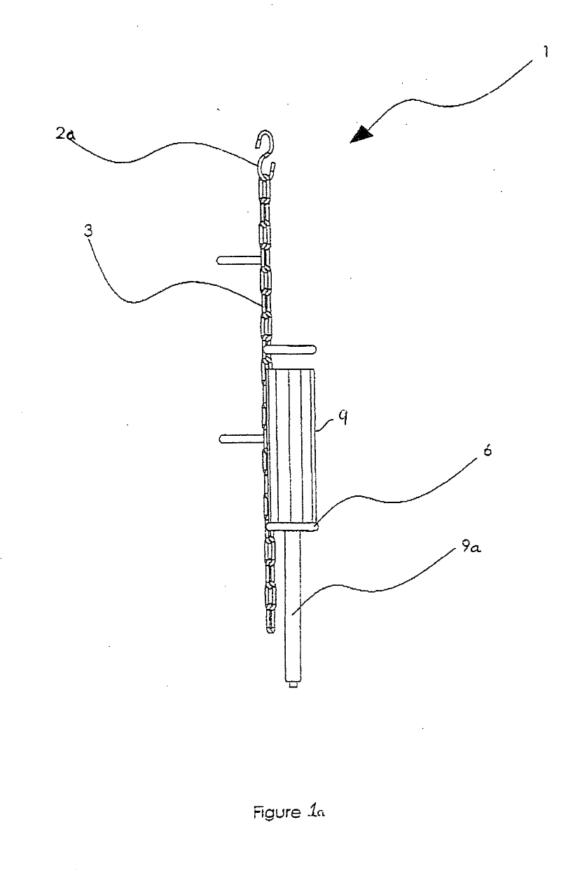

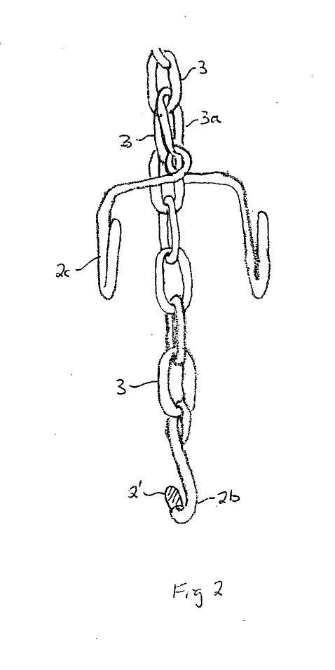

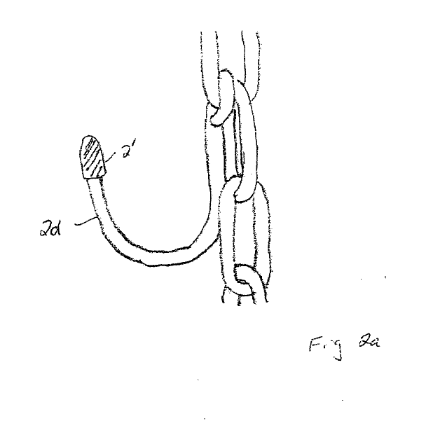

FIG. 2 illustrates an alternative embodiment of tool hanger 1. Instead of rings 6 being welded to links 3, or for example hooks 2b being rigidly welded to links 3, hooks including for example single hooks 2b and double-ended hooks 2c are mounted to links spaced-apart along the chain so that the hooks are free to swing. Thus hook 2b may be in the form of an S-hook with the upper end of the S bent so as to fold down upon the shank of the hook to thereby secure the hook 2b for example at the lower-most link 3 while still allowing hook 2b to swing freely. Hook 2c may be mounted for example by means of a removable carabiner or fixed link 3a to links 3 which are spaced along the length of the chain. The hooks may include rubber tips 2′.

As seen in FIGS. 2b and 2c, rings 6 may be mounted to a link 3, either as a single ring or multiple rings so as to hang freely from the link. As seen in FIGS. 2d and 2e, either the hooks or the rings may alternatively be mounted to releasably engagable clasps, for example, spring-loaded lobster-claw hooks 3b. The use of releasable clasps allows the selectively positionable mounting of hooks and rings onto convenient links 3 so that the arrangement of hooks and rings may be easily adjusted by the user to accommodate the type and positioning of the various tools being hung.

Without intending to be limiting, double-ended hooks 2c may be used to hang shovels, rakes, and like implements having elongate heads which extend in opposite directions perpendicularly from the handle. Smaller diameter rings 6, for example 1 inch diameter rings, may be employed to hang ratchets, screwdrivers as in the manner illustrated in FIG. 1a, etcetera. Larger rings such as for example 2 inch diameter rings 6 may be used to hang larger hand tools such as hammers, axes, pliers, etcetera. Single hooks such as hooks 2b and 2d, may be used for example to hang hand saws or like tools having a loop handle through which the hook may be engaged, or for hanging for example power tools on which are provided eyelets such as now commonly found, in which case, the hooks are journalled through the eyelets.

With respect to the embodiments where the hooks and rings are, however mounted, free to swing from the link 3 to which they are mounted, applicant has found that when supporting tools including heavy tools, the length of chain only minimally kinks as compared to the kinking of the chain when heavy tools are mounted into rings and hooks which are rigidly mounted to links 3.

It is understood that although the upper most end and the lower most end of the chain are shown having an S-hook 2a or not having a hook or ring at all, respectively, it is intended to be within the scope of the present invention to provide either hooks or rings or other tool supports at either end of the chain or for example to provide an eyelet at the upper end of the chain in order to accommodate ease of mounting of the chain to for example a stud or joist.

It is also intended to be within the scope of the present invention that instead of the use of a length of chain, other elongate flexible members which are strong in tension may be employed for example lengths of cable, resilient bungees or resilient cords, or tethers or lengths of leather, or rope, etcetera.

Thus the further embodiment shown in FIG. 3 uses a cable 7 in place of chain links 3. A series of spacers 5 and double cylindrical connectors 4 are slidably mounted along cable 7. A loop of cable 2e is secured by a connector 4 at the upper end of the cable. The spacers 5 and double cylindrical connectors 4 may alternate, or be arranged in other configurations, in order to best suit the user of the tool hanger. These configurations will vary based on the tools being hung. Arms 6 may be mounted in double cylindrical connectors 4, again according to the preference of the user and dependent upon the tools being hung. A loop of cable may be formed at the bottom end of cable 7 so as to prevent the spacers 5 and double cylindrical connectors 4 from sliding off the cable. Double cylindrical connectors 4 are rotatably mounted upon cable 7 so that tools may be placed at any orientation around the axis of the cable 7. This allows the user of the tool hanger the maximum flexibility in organizing and storing the tools.

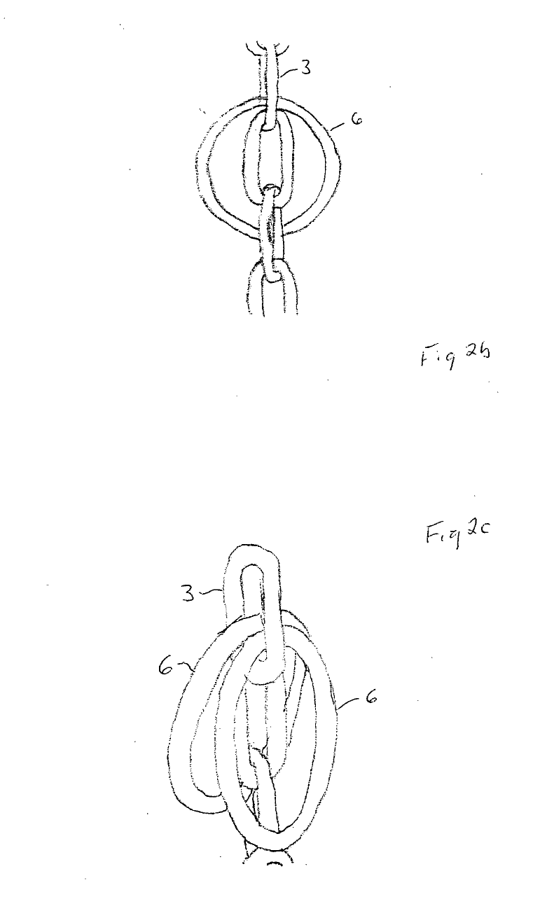

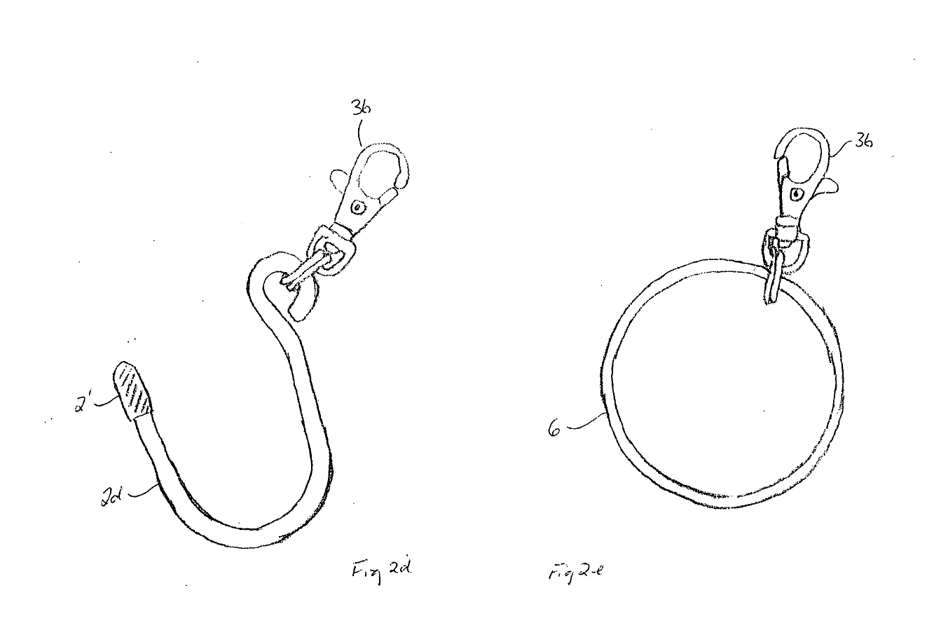

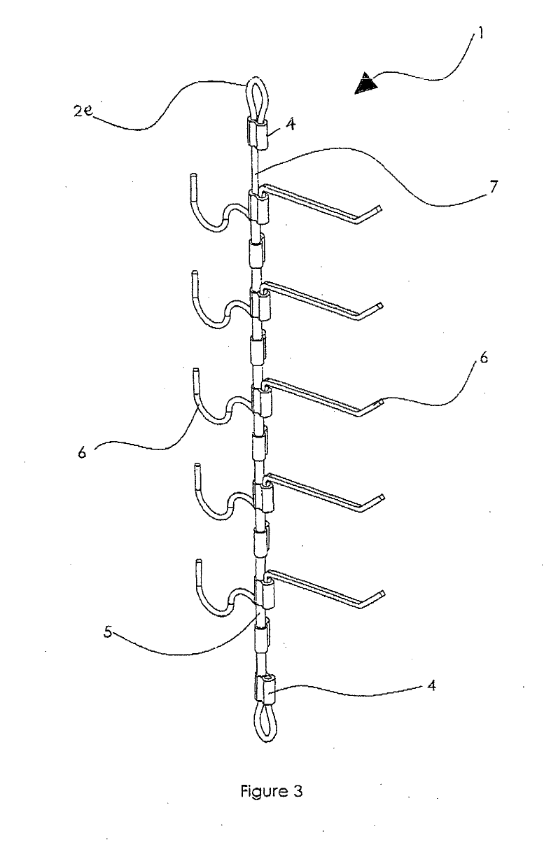

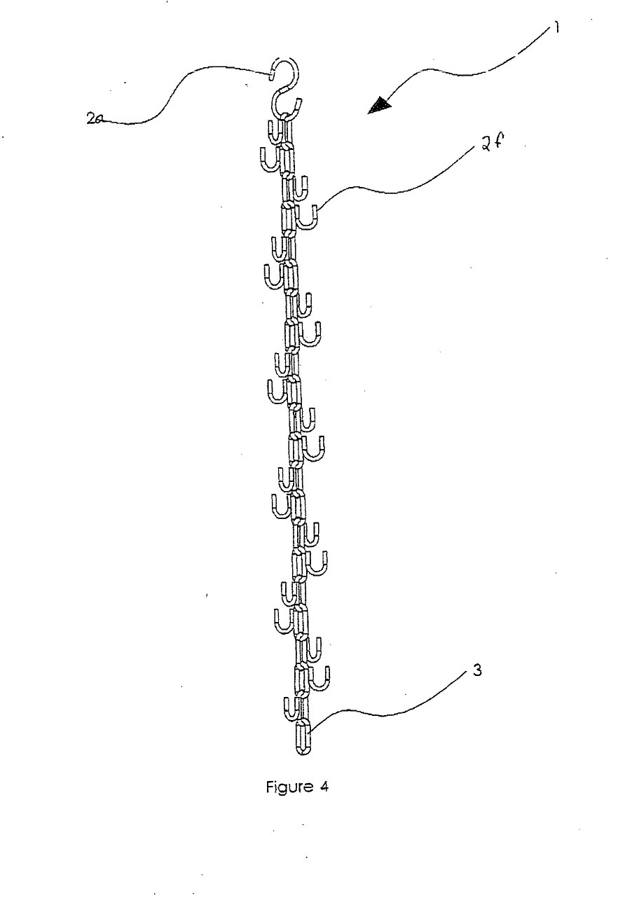

FIG. 4 illustrates an embodiment where a multitude of U-shaped hooks 2f are rigidly mounted to links 3 in radically spaced apart, staggered array along the length of the chain formed by links 3. Hooks 2f are spaced apart both radially about the longitudinal axis of the chain, when linear, and along the length of the chain again to accommodate tools of different shapes, sizes etcetera.

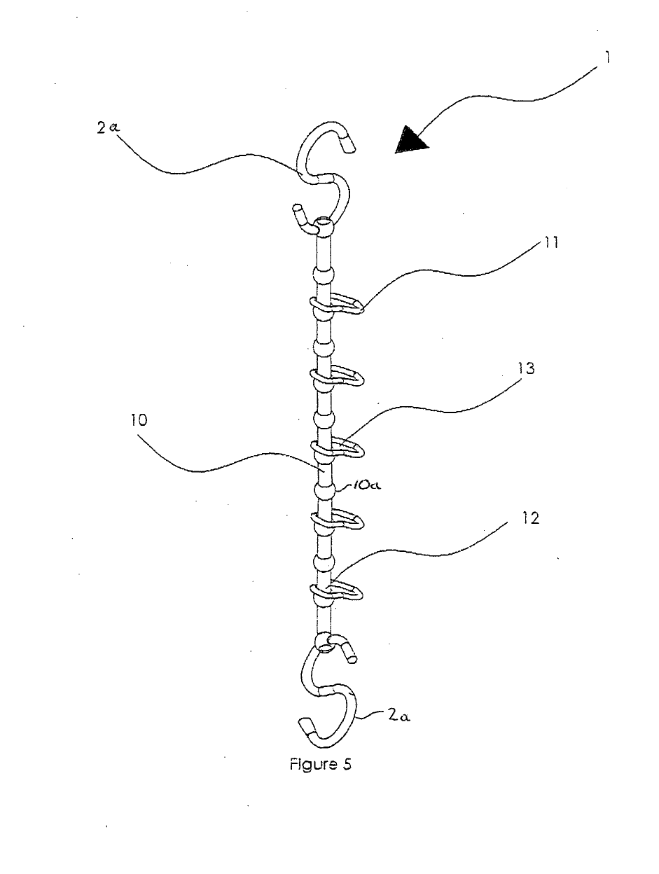

FIG. 5 illustrates another embodiment of the substantially vertically disposed tool hanger 1. A knotted rubber cord or bungee 10, which may also be formed with bumps 10a (instead of being knotted) supports keyhole rings 11. Rings 11 secure the tools. Each keyhole ring 11 has one end having a small aperture 12 and a larger aperture 13. Larger aperture 13 is slightly larger than bumps 10a. Smaller aperture 12 is smaller than the diameter of bumps 10a but larger than the thickness of bungee 10. Thus keyhole ring 11 may be slid up and down the bungee, with the larger aperture 13 passing over the bumps. When the desired position is reached along the bungee, the keyhole ring 11 is laterally shifted to move the bungee into the smaller aperture and so that the smaller aperture 12 then engages down upon one of the bumps. A tool may then be hung in the larger aperture 13. The engagement of the smaller aperture 12 down on the bump prevents ring 11 from sliding down along the bungee.

Tool hanger 1, may be attached by a screw, hook, nail or other suitable fastener to a suitable structure, for example a wall stud or ceiling joist. The tool hanger 1 is allowed to hang vertically, ready to receive tools. Applicant has found that it's not necessary to weight down the lower-most, that is, the free end of the chain or other flexible member in order to allow ease of hanging tools in the tool supports.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A tool hanger comprising:
An elongate flexible member,
A plurality of tool supports mounted spaced apart along said member, wherein said tool supports are chosen from hooks, loops, rings,
Wherein a said member has opposite first and second ends, and wherein said first end is adapted to be an upper end and mountable to a rigid support so as to allow said member to hang freely and downwardly by solely said first end,
And wherein said tool supports each have opposite first and second sides in diametrically opposed relation, and wherein each said tool support is mounted to a corresponding mounting position along said member by the mounting of said first side of said tool support to said corresponding mounting position so as to dispose said second side of said tool support away from said corresponding mounting position.

2. The device of claim 1 wherein at least one of said plurality of tool supports is a free hanging tool support mounted to said member so as to hang free from said member thereby allowing free movement of said free hanging tool support suspended by said first side of said free hanging tool support from said mounting position.

3. The device of claim 2 wherein said member is a length of chain comprising a linked series of chain links, and wherein said free hanging tool support is mounted to a corresponding link.

4. The device of claim 3 wherein all of said tool supports are said free hanging tool supports.

5. The device of claim 4 wherein at least one of said free hanging tool supports are releasably mounted to said member.

6. The device of claim 5 wherein all of said free hanging tool supports are releasably mounted to said member.

7. The device of claim 4 wherein none of said free hanging tool supports are releasable from said member.

8. The device of claim 2 wherein all of said tool supports are free hanging tool supports.

9. The device of claim 8 wherein said member is a chain.

10. The device of claim 9 wherein said chain includes a series of inter-linked chain links, and wherein said tool supports are mounted along said chain in a spaced apart array.

11. The device of claim 10 wherein at least one of said tool supports is a releasably mounted tool support, releasably mounted to a corresponding link of said chain links.

12. The device of claim 11 wherein said releasably mounted tool support is releasably mounted to said corresponding chain link by a manually operable clasp.

13. The device of claim one wherein said rings include rings of different diameters.

14. The device of claim 13 wherein said rings include first rings having a first diameter and second rings having a second diameter, wherein said first diameter is less than said second diameter, whereby said first and second rings are adapted to hold elongate parts of hand tools when the elongate parts are journalled therethrough.

15. The device of claim 14 wherein said hooks include hooks chosen from the group comprising: S-hooks, u-shaped hooks, single hooks, double-ended hooks.

16. The device of claim 15 wherein one of said hooks is mounted at said second end so as to hang below the lower-most end of said member when said member is hung up by said first end and said member hands free from said first end.

17. The device of claim 16 wherein another of said hooks is mounted at said first end of said member, and wherein said member is suspended thereby.

18. The device of claim 1 wherein said tool supports are adjustably positionable along the length of said member.

19. The device of claim 18, wherein said tool supports are adjustably positionable radially about said length of said member.

20. The device of claim 1 wherein said flexible member is chosen from the group comprising: chain, cable.
